(19) United States
(12) Patent Application Publication
(10) Pub. No.: US 2012/0159424 A1
(43) Pub. Date: Jun. 21, 2012

(54) DISTRIBUTED APPLICATION MANIFEST

(75) Inventors: Dharma Shukla, Sammamish, WA (US); Akash Jeevan Sagar, Redmond, WA (US); Nathan C. Talbert, Seattle, WA (US); Muthukaruppan Annamalai, Kirkland, WA (US); Robert B. Schmidt, Carlsbad, CA (US); Aditya Bhandarkar, Sammamish, WA (US); Asad Jawahar, Woodinville, WA (US)

(73) Assignee: Microsoft Corporation, Redmond, WA (US)

(21) Appl. No.: 12/975,127

(22) Filed: Dec. 21, 2010

(51) Int. Cl. G06F 9/44

(52) U.S. Cl. 717/103

(57) ABSTRACT

A method of creating a manifest for a distributed application is disclosed. Components and composites of components of the distributed application are described in a technology agnostic manner. The description includes a definition of the scalability of the composites of components.

### BACKGROUND

Distributed computing applications are often constructed to include a collection of different technologies and services that form building blocks of the applications. Examples of distributed applications are legion and can include enterprise applications such as line of business or LOB, billing systems, customer relationship management or CRM, enterprise resource planning or ERP, business intelligence, human resource management, manufacturing, and inventory control applications. Distributed applications are typically distributed across tiers in a computer network and can include composites of components built using disparate technologies, which can include both familiar and emerging technologies. Some applications run in a cloud computing environment, others run on the premises of the entity or user, and others span these environments. Further, the environment may change as an application evolves.

One desirable characteristic of a distributed application is its ability to scale, or cost effectively change with the enterprise. Existing application models do not aim to support the development of scalable distributed applications. Typical component models are designed for desktop applications and are tier and technology specific. A distributed application is typically comprised of a set of distinct components, spread across tiers, which interact to perform work. While the components are virtualized, the relationship between the components is not. A physical wiring of components during runtime interaction is typically statically determined or otherwise hard-coded in this framework, which can place limits on the ways in which the application can be scaled or even on the application's overall ability to scale. While working with such models, many developers try to avoid writing stateful components because they are difficult to scale, but in making this choice the developer sacrifices benefits of other approaches, such as the natural expression of application logic.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

The present disclosure is directed to an application manifest of a distributed application constructed according to an application model in an application framework. The application model includes an application being constructed from one or more modules each including one or more components. The manifest describes components and composites of components of the distributed application in a technology agnostic manner and defines the scalability of the composites of components. In some examples, the manifest includes the metadata of each component, and each component can define its own metadata that becomes part of the distributed application. The manifest further defines external services and defines applications consumed by the distributed application and artifacts. Cross cutting concerns for the distributed application such as metering, throttling, billing can also be described.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a block diagram illustrating an example computing device for running, hosting, or developing a distributed application.

FIG. 2 is a schematic diagram illustrating features of an example distributed application.

FIG. 3 is a block diagram illustrating a manifest of the example distributed application of FIG. 2.

FIG. 4 is a schematic diagram illustrating a visual rendering of the manifest constructed in accordance with FIG. 3.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that features of the various exemplary embodiments described herein may be combined with each other, unless specifically noted otherwise.

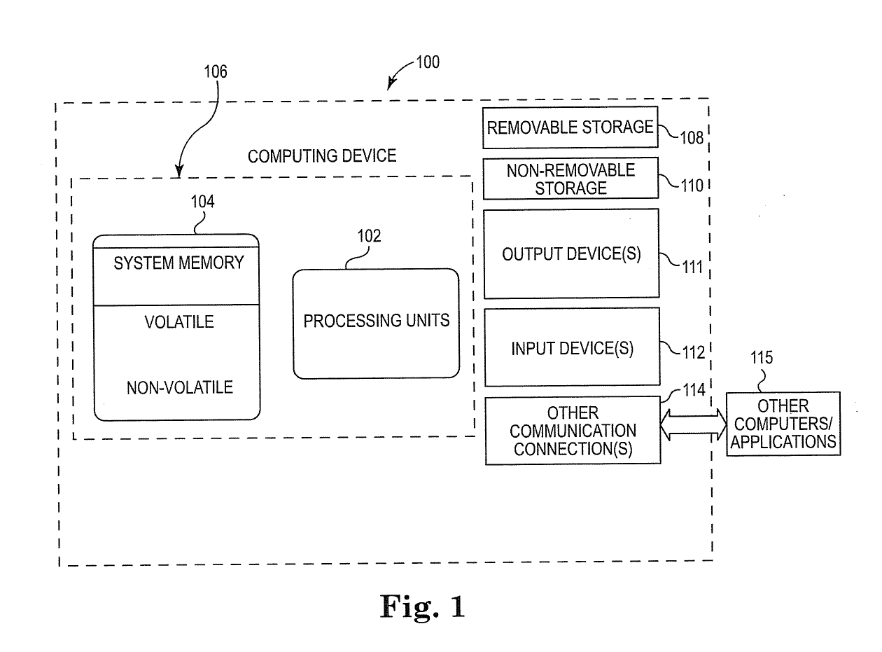

FIG. 1 illustrates an exemplary computer system that can be employed in an operating environment such as a distributed computing system or other form of computer network and used to host or run a distributed application included on one or more computer readable storage mediums storing computer executable instructions for controlling a computing device or distributed computing system to perform a method. The computer system can also be used to develop the distributed application and/or provide a serialized description or visualized rendering of the application.

The exemplary computer system includes a computing device, such as computing device 100. In a basic configuration, computing device 100 typically includes a processor system having one or more processing units, i.e., processors 102, and memory 104. Depending on the configuration and type of computing device, memory 104 may be volatile (such as random access memory (RAM)), non-volatile (such as read only memory (ROM), flash memory, etc.), or some combination of the two. This basic configuration is illustrated in FIG. 1 by dashed line 106. The computing device can take one or more of several forms. Such forms include a person computer, a server, a handheld device, a consumer electronic device (such as a video game console), or other.

Computing device 100 can also have additional features or functionality. For example, computing device 100 may also include additional storage (removable and/or non-removable) including, but not limited to, magnetic or optical disks or solid state memory, or flash storage devices such as removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, universal serial bus (USB) flash drive, flash memory card, or other flash storage devices, or any other medium that can be used to store the desired information and that can be accessed by computing device 100. Any such computer storage media may be part of computing device 100.

Computing device 100 includes one or more communication connections 114 that allow computing device 100 to communicate with other computers/applications 115. An example communication connection can be an Ethernet interface. In some examples, the computing device can also have one or more additional processors or specialized processors (not shown) to perform processing functions offloaded from the processor 102. Computing device 100 may also include input device(s) 112, such as keyboard, pointing device (e.g., mouse), pen, voice input device, touch input device, etc. Computing device 100 may also include output device(s) 111, such as a display, speakers, printer, or the like.

The computing device 100 can be configured to run an operating system software program and one or more software applications, which make up a system platform. In one example, the computing device 100 includes a software component referred to as a managed, or runtime, environment. The managed environment can be included as part of the operating system or can be included later as a software download. Typically, the managed environment includes pre-coded solutions to common programming problems to aid software developers to create applications, such as software programs, to run in the managed environment.

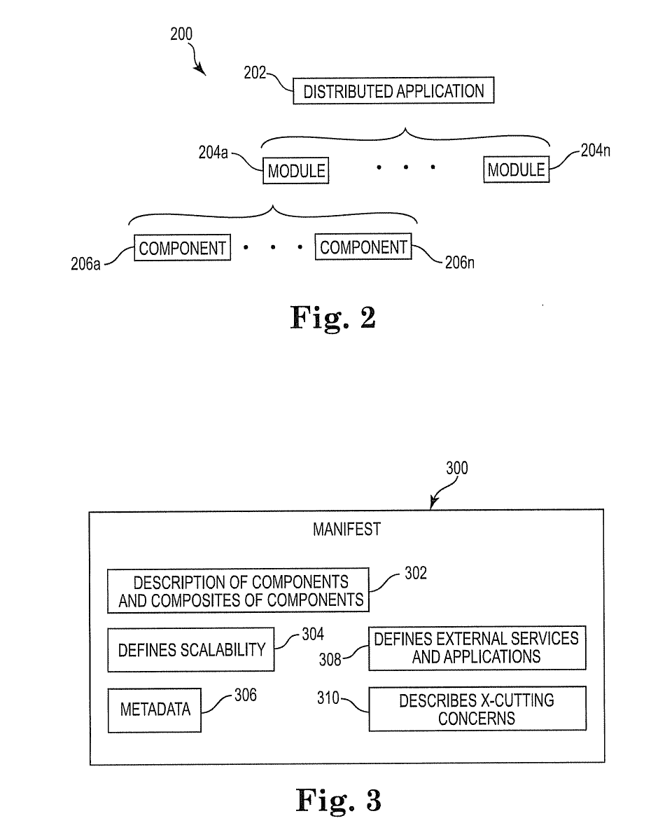

FIG. 2 illustrates a schema 200 for a distributed application 202. The application 202 contains one or more modules 204a-204n that contains one or more components 206a-206n that specify imports and exports. The application 202 has an identity and is a unit of deployment and management. The application 202 spans tiers, which can include a client tier in many forms; a web tier, which is typically stateless, that can be available all of the time; a worker tier, including stateless and stateful components, that provides much of the logic of the application 202; and a storage tier that can be located on premise and/or in the cloud environment. A module 204a is a tier-specific unit of hosting for a logical grouping of components that share execution characteristics. A component 206 is a unit of composition. A component exports, or offers, a set of capabilities and imports, or uses.

A component, such as component 206a, is a unit of technology encapsulation, extensibility, and composition. The component 206a encapsulates a certain technology. Technologies can include, for example, a web application technologies or application programming interfaces for building connected, service-oriented applications. More than one component type can be developed for a given technology. For example, the application 202 could include a web application component and a service component in the web tier, a code component, a cache component, and a workflow component in the worker tier, and various storage components (such as tables or queues) an SQL database component in the storage tier. The component 206a can include artifacts and define the metadata at runtime.

Imports and exports are the mechanism by which the components 206a-206n are stitched together to form the application 202. This stitching may be described at the design stage or can be dynamic in that available exports can be discovered, imported, and used at runtime. In either case, the stitching is a logical expression of a component relationship; the procurement of proxies and the resolution of physical addresses to get two component instances communicating is brokered at runtime.

In the schema 200, one or more components can be organized as a module 204a-204n. A module is a tier-specific unit of hosting for a logical grouping of components that share execution characteristics. Components grouped together within a module can run within the same application domain. For example, two or more components 206a-206n can be co-located if they abide by the same partitioning scheme. In a partitioned module, each part is independent of the others and hence receives its own application domain (within which the set of co-partitioned components constituting that part will run). The components 206a-206n within a module, such as module 204a, can communicate via direct method invocations. Across modules 204a-204n, components communicate by sending messages. A module type can correspond to the capability of the host. For example, a stateless component, such as a web role, can be hosted in a stateless module. Execution environments for modules include web and worker roles for stateless components and a fabric role for stateful components.

In one example of an application model, the scalable application 202 can include the techniques of cloning, replication, and partitioning. Different techniques may apply to different parts of the application 202, which may change over time as the application grows. For example, cloning is a relatively straightforward technique, but it is exclusively suited for stateless components. Replication is an effective technique for stateful components, but it can be complex and limited. For example, the amount of state can grow during the life of the application 202 such as in the form of user sessions or cached data that are replicated across machines, or a row-locking scheme in a shared store that becomes the bottleneck to the performance of the application 202. In order to address the issue of growing state, a developer may choose to partition the component 206a, which at times can involve a costly and difficult re-architecture of the application 202.

In order to avoid a costly re-architecture, the application 202 is initially designed in a distributed application framework to support partitioning. Design patterns and use of a distributed composition runtime can make intra-component wiring immune to otherwise invasive changes such as sharding, or horizontal partitioning of a database, and component partitioning. Partitioning is made available in the application 202 and activated at as desired. The application 202 can be readily designed to map the partitions to machines as well. Additionally, the developer can retain flexibility about whether a component 206a or the entire application 202 runs on premise or in a cloud computing environment. As the costs of infrastructure change over time, the architecture of the application 202 can naturally evolve to take advantage of the relative cost changes.

Architects, developers, and information technology personnel can all benefit from using a single, consistent application model that is used to describe the application 202. The application model can span tiers and technologies, embrace both stateless and stateful components, and offer an ability to readily control partitioning and cloning throughout the lifetime of the application 202. At runtime, the distributed application framework provides the connections between the components 206a-206n of the application 202, described logically in the model of the application.

The distributed application framework provides developers and enterprises the ability to cost-effectively build, run, and evolve the distributed application 202. Both stateful and stateless components can be developed using familiar technologies, emerging technologies, and custom paradigms for specific domains. The components 206a-206n can be stitched together either statically or dynamically to form the application 202. Cloning, replication, and partitioning are supported within the application 202, as is the ability to make architectural tradeoffs such as among consistency, availability, and tolerance of “partitions” (such as describe in Brewster's CAP Conjecture).

During runtime, the distributed application framework can monitor the application 202 to diagnose and repair issues as well as meter the use of the components 206a-206n. The distributed application framework can elastically allocate and reclaim resources to support a fluctuating demand. Further, the distributed application framework provides for the ability to later partition the application 202, co-locate partitioned components 206a-206n, change a mapping of partitions to a physical infrastructure, as well a shard a database without costly re-architecture.

In one example, an application fabric available under the trade designation of AppFabric can run on premise, such as a server operating system available under the trade designation of Windows Server, and in a cloud environment having a cloud computing or cloud services operating system available under the trade designation Windows Azure, all available from Microsoft, Inc., allowing entire applications (or components within them) to be deployed to either environment. Web roles, workflow, and the like can be built using Windows Communication Foundation (WCF) and Windows Work Flow (WF) available from Microsoft, Inc.

A distributed application manifest provides a description, or definition, of the components 206a-206n, the composites of components, and their relationship to each other within the distributed application 202 in a technology and format agnostic manner. The manifest is a serialized form of the distributed application 202 and captures the entire structure of the application.

FIG. 3 illustrates a block diagram of an example distributed application manifest 300. The manifest 300 provides a description of the components and the composites of the components in the application 302. It also defines the scale and availability capabilities of components and composites of components including cloning, replication, and partitioning 304. The manifest 300 includes the metadata of each component, and each component can define its own metadata that becomes part of the overall application 306. The manifest further defines external services and applications consumed by the application and defines the artifacts used to consume them 308. The manifest 300 also describes cross cutting concerns for the application such as metering, throttling, billing, and the like 310.

The manifest 300 can be used to create a visualization of the distributed application in a development tool such as an integrated development environment available under the trade designation of Visual Studio from Microsoft, Inc., of Redmond, Wash. The deployment infrastructure can make use of the manifest 300 to determine how to configure a node in a host farm and which components to co-locate. Additionally, a management experience can allow configuration of component metadata and scale properties prior to and after deployment of the distributed application.

In one example, the manifest is format agnostic and can be serialized in a variety of formats, which can include scripting languages such as extensible markup language (XML), extensible application markup language (XAML), JavaScript object notation (JSON), or binary JSON (BSON) and many others now know or yet to be created. The following example distributed application manifest is serialized in JSON:

{
“Name”: “MyApp”,
“Id”: “622BN4TFQB3UHFEERJGFXPVX4A”,
“BaseUri”: http://MyApp.cloudapp.net/,
“SelfLink”: “...”,
“Version”: “1.0.0.100” ,
“References”: [

{“Type”: “DistributedList”,...}, {“Type”:“TaskScheduler”,...}, {“Type”:“CloudQueue”,...},

{“Type”: “WCFService”,...} ],

“ModuleDefinitions”:
[

```
{“Name”: “MyWebModule”, Type” : “Web”, “InstanceCountHint”: 2, “Components”: [ {...}] },
{“Name”: “MidTierModule”, “Type” : “Stateful”, “InstanceCountHint”: 2,
“IsolationLevel”: “Process”, “MachineSize”: “Large”,
“PartitionPolicy”: { “Type”: “RangePartitionPolicy”, “Keys”: [ “A-G”, “H-M”,“N-Z”] },
  “ReplicaCountHint”: 2, “ReplicationFormat”: “JSON”, “WriteQuorum”: 1,
  “Components”:
  [
```

```
{“Name”: “MovieProcessor”, “ModuleAffinity”: “Stateful”, ...
  “Imports”:
  [
```

{“Name”: “DistributedList”, “Cardinality”: “ExactlyOne”, “InstancingPolicy”:

“Pooled”, “Constraint”: {...} } },

{“Name”: “NewMovies”, “Cardinality”: “AtleastOne”, “InstancingPolicy”:

“Singleton”, “Constraint”: {...} } },

{“Name”: “MovieService”, “Cardinality”: “AtleastOne”, “InstancingPolicy”:

“Singleton”, “Constraint”: {...} } },

{“Name”: “TaskScheduler”, “Cardinality”: “AtleastOne”, “InstancingPolicy”:

“Singleton”, “Constraint”: {...} } },

],
}

]
}

```
  ...
  ]
  ...
}
```

The manifest 300 includes a module definition and information on instances, partitions, and replicas. For example, a stateless module definition can include an instance count that control the number of module instances and describes the scalability and high availability (HA) characteristics of a stateless module. A stateful module definition can include an instance count, a partition policy, and a replica count. Again, the instance count controls the number of module instances and thus the scalability. The partition policy defines the number of partitions assigned to a given module instance. The replica count controls the HA and determines the number of replicas of each partition. For example, a stateless module definition can specify three stateless module instances. A stateful module definition can define three stateful module instances, where each stateful module can have four partitions, and each partition can have two replicas.

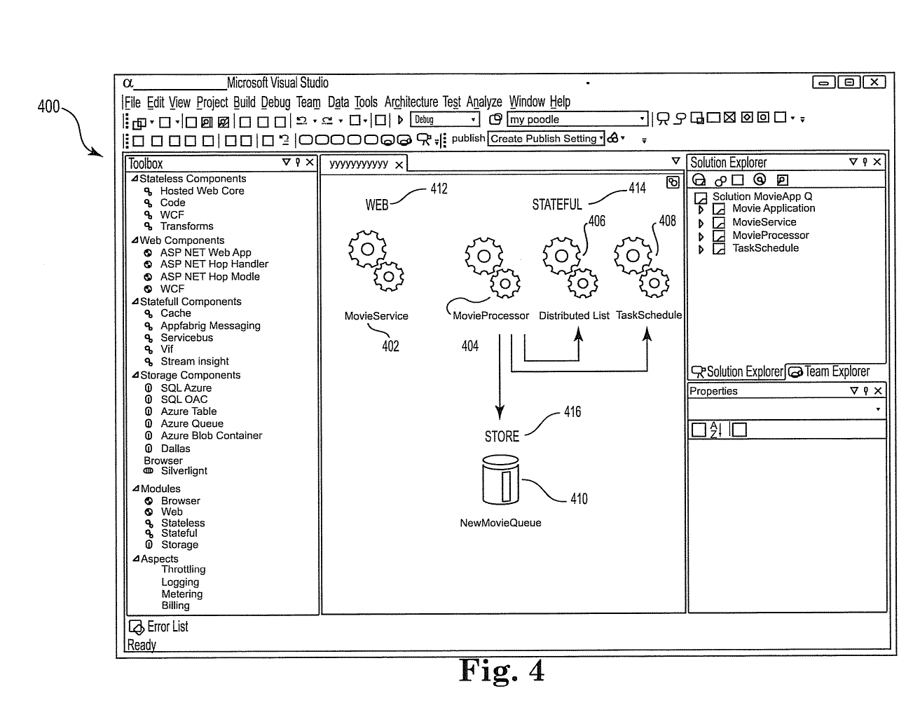

FIG. 4 illustrates an example visualization 400 of the compositional relationships described in the manifest listed above in JSON format. In one example, the visualization 400 can be included as part of a distributed application designer feature of the integrated development environment Visual Studio from Microsoft, Inc. The visualization describes a plurality of modules including a movie service module 402, a movie processor module 404, a distributed list module 406, a task scheduler module 408, and a new movie queue module 410. The visualization uses arrows to indicate the relationships between the modules to define the distributed application. The movie service module 402 is indicated as hosted in a stateless web tier 412. The movie processor module 404, distributed list module 406, and task scheduler module 408 are grouped together and indicated as each being hosted in a stateful mid-tier module, such as a worker tier 414. The new movie queue module is indicated as hosted in a storage tier 416.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of creating a manifest for a distributed application, comprising:
describing components and composites of components of the distributed application in a technology agnostic manner, wherein the describing includes defining scalability of the composites of components.

2. The method of claim 1 and further comprising representing the metadata of the components.

3. The method of claim 1 and further comprising serializing the manifest.

4. The method of claim 3 wherein the manifest is serialized from a scripting language.

5. The method of claim 1 wherein a composite of components is combined into a module describing a tier-specific unit of hosting for a logical grouping of components that share execution characteristics.

6. The method of claim 5 wherein scalability is defined in a module definition including an instancing count.

7. The method of claim 6 wherein the module is stateless.

8. The method of claim 7 wherein the module definition is directed to cloning the module.

9. The method of claim 6 wherein the module definition further includes a partition policy and a replica count.

10. The method of claim 5 wherein tiers include a web tier, a worker tier, and a storage tier.

11. The method of claim 5 wherein the web tier is stateless.

12. The method of claim 9 where in the worker tier is stateful.

13. The method of claim 1 wherein defining the scalability includes defining the scalability of at least one of a stateless component and a stateful component.

14. A computer readable storage medium storing computer executable instructions for controlling a computing device to perform a method comprising:
describing components and composites of components of the distributed application in a technology agnostic manner, wherein the describing includes defining scalability of the composites of components.

15. The computer readable storage medium of claim 14 and further comprising representing the metadata of the components.

16. The computer readable storage medium of claim 14 and further comprising serializing the manifest.

17. The computer readable storage medium of claim 14 and further providing a visualization of the compositional relationships of the distributed application.

18. The computer readable storage medium of claim 17 wherein modules of the distributed application are group together by tier.

19. The computer readable storage medium of claim 14 wherein modules of the distributed application include an instancing count to define scalability.

20. A method of creating a manifest for a distributed application, comprising:
describing components and composites of components of the distributed application in a technology agnostic manner, wherein the describing includes:
defining scalability of the composites of components;
representing component metadata;
describing artifacts of the distributed application;
describing external services consumed by the distributed application; and
describing cross cutting concerns.
